(19) United States
(12) Patent Application Publication
(10) Pub. No.: US 2003/0002667 A1
(43) Pub. Date: Jan. 2, 2003

(54) Flexible prompt table arrangement for a PIN entery device

(76) Inventors: Dominique Gougeon, Rocklin, CA (US); Jeff Zentner, Rocklin, CA (US)

Correspondence Address: HEWLETT-PACKARD COMPANY, Intellectual Property Administration, P.O. Box 272400, Fort Collins, CO, 80527-2400, US

(21) Appl. No.: 09/893,478

(22) Filed: Jun. 29, 2001

(51) Int. Cl. H04L 9/00

(52) U.S. Cl. 380/44; 713/168

(57) ABSTRACT

Prompt tables that permit numeric keys on the keypad of a PINpad terminal to be used for entry of numerical data other than PINs if and only if pre-formatted prompts or messages appropriate to the data have been previously displayed, are provided in the form of an authenticatable files that may be loaded into the PINpad, thereby permitting variation in the prompts and keypad assignments.

### BACKGROUND OF THE INVENTION

1. Field of the Invention

The invention relates to a type of transaction terminal known as a PINpad, and in particular to a system and method for enabling displayed user prompts and numeric keypad assignments, i.e., the manner in which digits input through the numeric keypad are interpreted and processed, to be secured so as to permit entry of information other than PIN numbers using the keypad of the PINpad. The invention also relates to a system and method for enabling the secured user prompts and keypad assignments to be varied or updated after installation of the PINpad.

The invention uses a prompt table to associate the user prompts with keypad assignments, thereby permitting numeric keys on the keypad to be used for entry of numerical data other than PINs if and only if pre-formatted prompts or messages appropriate to the data have been previously displayed, and are still on the display when the data is entered. Unlike conventional static prompt tables used for the same purpose, however, the dynamic prompt tables of the preferred embodiment of the invention are in the form of authenticatable files that may be loaded into the PINpad, thereby permitting variation in the prompts and keypad assignments.

In accordance with the principles of an especially preferred embodiment of the invention, the authentication procedure involves use of a smart card having an embedded private key to sign the prompt table file, a signer's public key certificate to be transferred with the prompt table file, and authentication of the signer's public key certificate based on an owner's or sponsor's public key certificate stored in the PINpad.

2. Description of Related Art

A PINpad is a small device featuring a basic keypad with numeric keys, function keys, and a small display. The PINpad's primary function is to permit a user to enter a PIN, and to securely communicate the PIN to an external computing device. This means that the PIN never leaves the device in plaintext, but rather must always be encrypted before being retrieved from the PINpad. A typical displayed message is “Enter your PIN.” Once the PIN is entered, the PINpad encrypts the number and sends it to a remote location for verification by comparison with a PIN stored in a database.

In addition to entry of PINs for verification, the PINpad may be used to enter non-numeric information such as selection of a transaction type or amount approval. In the first generation of PINpads, these functions were handled by dedicated function keys, with the numeric pad being solely for the purpose of entering PINs.

However, there has been an increasing demand for PINpads capable of handling entry of numeric information other than PINs, such as zip codes, odometer readings, or license numbers, which are echoed back on the display sent out in plain text rather than cipher, upon display of appropriate prompts such as “Enter License Number.” In order to limit the ability of a malicious programmer to modify the prompts and trick the user into entering a PIN or other sensitive information when the information will be sent out in plaintext, the conventional approach is to pre-store prompts and enable the numeric keys only when a corresponding prompt is displayed. The association of prompts and numeric key enablement is handled by a static table known as a “prompt table” that is included in the PINpad firmware.

The prompt table protects data entry by enabling numeric keys to be used for data entry other than a PIN if and only if pre-formatted and known messages are previously displayed and are still on the display when the digits are entered. The messages are gathered in the static prompt table.

The major disadvantage of the conventional static prompt table is its inflexibility. The messages have to be known up-front when the PINpad is built, since the prompt table is included in the PINpad firmware. If new messages are necessary for a given application, then a new firmware version has to be created and a new PINpad version built. Moreover the programmer needs to know how the messages are ordered in this prompt table so as to be able to select the correct one at the correct time. In addition, messages in this arrangement can only be displayed in association with a specific display function.

### SUMMARY OF THE INVENTION

It is accordingly a first objective of the invention to provide a system and method for enabling the numeric keypad of a PINpad to be used for entry of data other than PINs, while ensuring that prompts associated with the data entry correspond to the type of data entered, thereby preventing a malicious programmer from causing a prompt to be displayed that calls for input of sensitive data such as a PIN, when digits input to the keypad are to be sent out in plain text.

It is a second objective of the invention to provide a system and method of using a prompt table to enable the numeric keypad of a PINpad to be used for entry of data other than PINs, and that further permits variation in the prompts and key assignments permitted by the prompt table.

These objectives are achieved, in accordance with the principles of a preferred embodiment of the invention, by arranging a prompt table that correlates user prompts with key assignments to be dynamically loaded into the PINpad as an authenticatable file, at any time during the PINpad life, and by using digital signing techniques to ensure that the prompt table loaded in the this method is authentic. Further, the invention enables multiple prompt tables to be loaded and co-exist in the device, thereby enabling several languages to be invoked or the use of the PINpad device in connection with different remote applications with different needs.

Unlike the conventional static prompt table mechanism, the display of a prompt controlled by the dynamic prompt table of the preferred embodiment of the invention may be carried out using an existing display interface function, thereby eliminating the need for a special interface. The mechanism is implemented in such a way that any message sent to the display will enable the numeric keys to be echoed on the display, but entered digits will only be processed for transmission outside the PINpad if the message is part of one of the loaded prompt tables. In other words, in the preferred embodiment of the invention, only the messages present in one of the loaded prompt tables activate the numeric keys. Since addition of new prompts or messages can be carried out simply by uploading a new prompt table file, the programmer requires no knowledge of the organization of existing prompt table files to activate the numeric keys.

While the method of the invention may be used with any terminal system capable of file authentication and generation of a random number, and is not to be limited to any particular authentication method, in an especially preferred embodiment of the invention, the clear file containing the random number is signed by a system that includes a private key contained on a smart card protected by multiple PINs, and a corresponding public key certificate modified to include a clear string in, for example, the FileType field, and in particular that includes the following elements:

a certification authority/smartcard management system that issues smartcards containing a signer certificate, a private key for generating digital signatures, one or more PINs for accessing each of the smartcards, and an embedded secured processor capable of performing all digital signing operations that require access to the private key;

a customer file signing tool including a smartcard reader arranged to digital sign a file upon input by the user of one or more PINs corresponding to the PIN or PINs on the smart card, the smartcard performing all operations that require access to the private key before supplying the results of the operations to the customer file signing tool for further processing as necessary to generating a digital signature that can be appended to the file together with the signer certificate and downloaded to the terminal;

a terminal to which the signed file is to be downloaded, the terminal including a means for verifying the digital signature according to the signer certificate, and a higher level “sponsor certificate” or “owner certificate” for authenticating the signer certificate. It is noted that the term “sponsor certificate” is generally equivalent to the term “owner certificate,” and that these terms are used interchangeably herein.

### BRIEF DESCRIPTION OF THE DRAWINGS

FIG. 1 is a flow chart illustrating a method of clearing or restoring a terminal to its default state in accordance with the principles of a preferred embodiment of the invention.

FIG. 2 is a schematic diagram of a key management and file authentication system in which the method and system of the preferred embodiment may be utilized.

FIG. 3 is a flowchart of a key management and file authentication method corresponding to the system illustrated in FIG. 2.

### DETAILED DESCRIPTION OF THE PREFERRED EMBODIMENTS

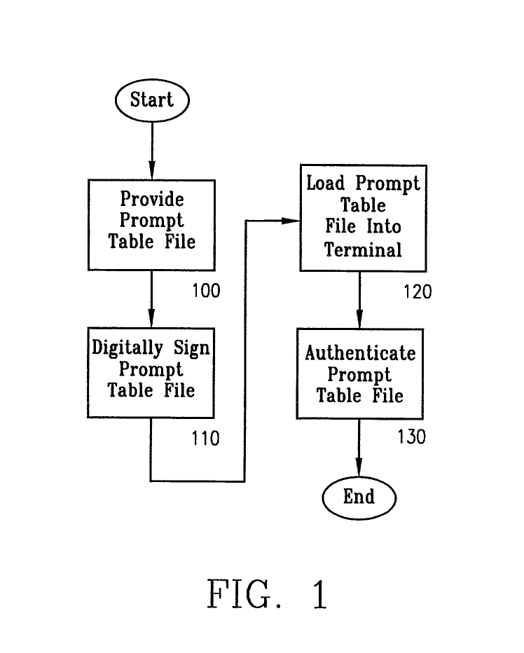

As illustrated in FIG. 1, the preferred method of enabling the numeric keypad of a PINpad to be used for entry of data other than PINs, and of enabling the prompts and keypad assignments used to facilitate entry of such data to be varied, involves the following steps:

providing a file including a prompt table having as entries a list of prompts and corresponding keypad assignments (step 100);

digitally signing the prompt table file (step 110);

loading the prompt table file into a terminal (step 120); and

authenticating the prompt table file (step 130), after which data entered through the keypad may be processed, according to entries in the prompt table, as non-PIN data if and only if a corresponding prompt has been, and continues to be, displayed on a display of the PINpad.

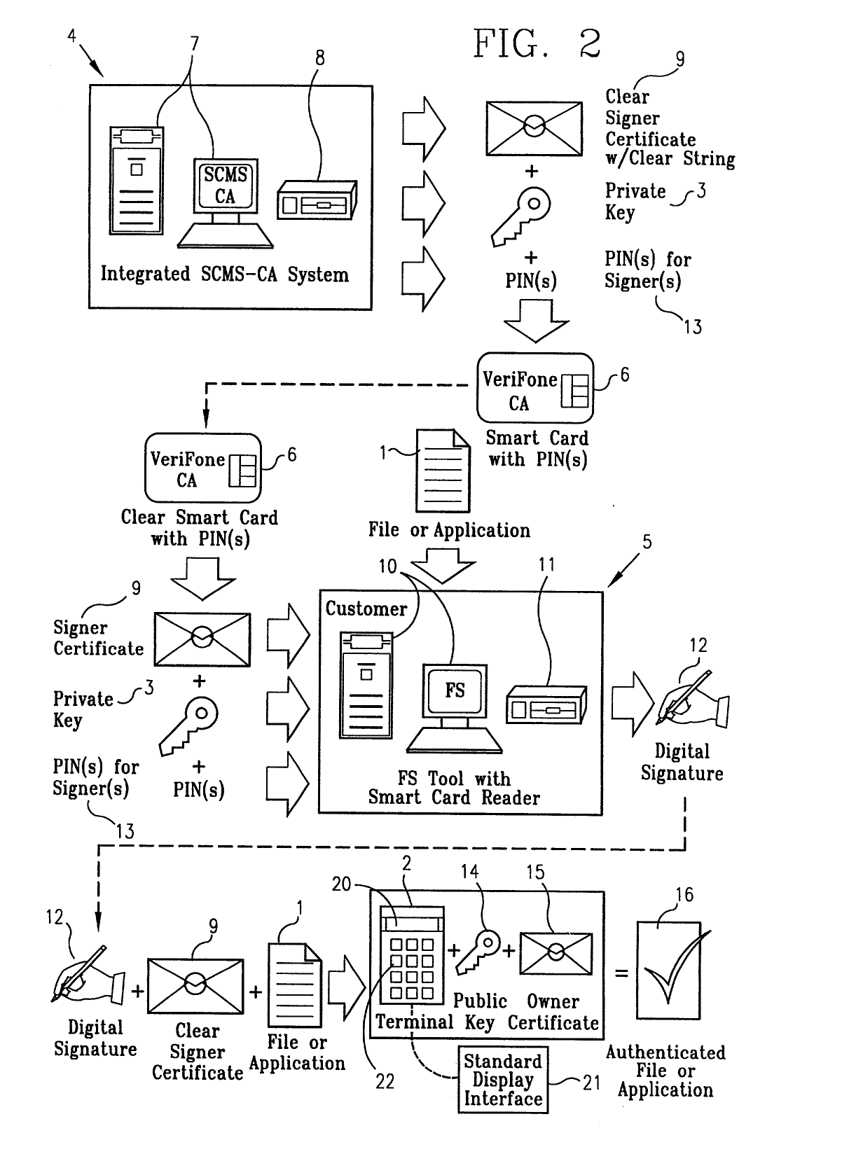

Turning to FIG. 2, the preferred system includes a terminal 2 having a display 20 and standard display interface 21, a numeric keypad 22, function keys 23, software for displaying prompts in response to pressing of selected ones of the function keys 23 and for processing data input through the numeric keypad in accordance with the selected functions, and one or more prompt table files arranged to initiate said data processing in response to display of prompts listed in the prompt table.

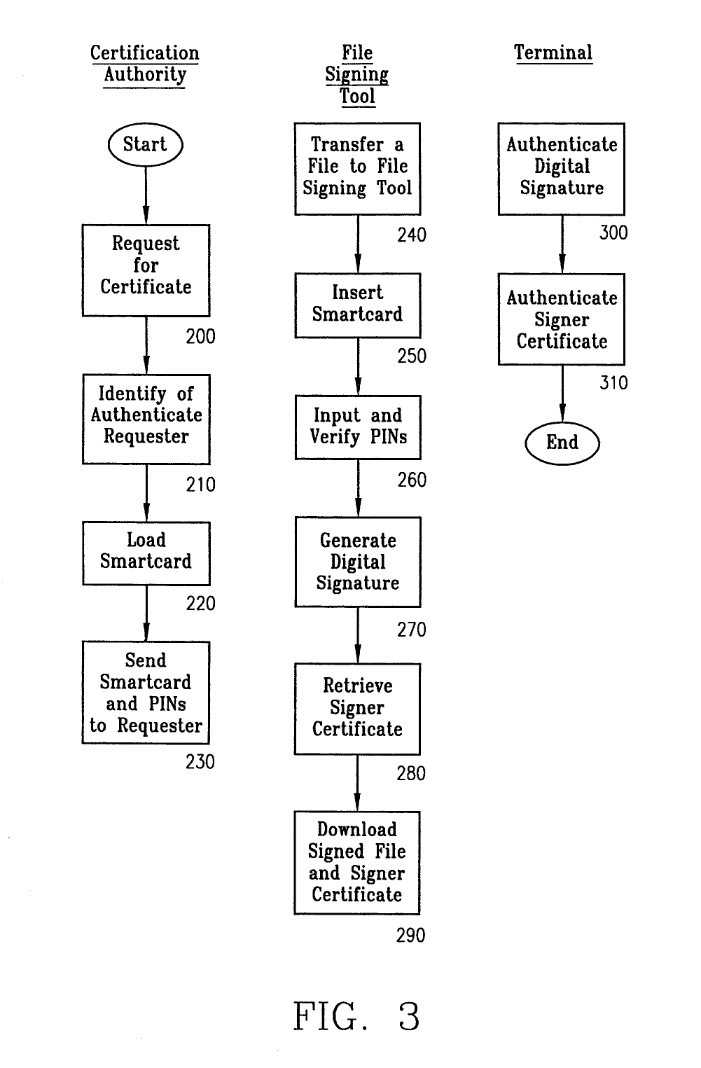

According to the principles of the invention, the prompt table files are arranged to be loaded into the terminal using an appropriate file authentication method. One example of a file authentication arrangement, although it will be appreciated by those skilled in the art that, for purposes of the present invention, any file authentication system capable of authenticating a signed prompt table file may be used, and that the specific file authentication system illustrated in FIG. 2, and the method illustrated in FIG. 3, are included herein solely for purpose of illustration and not by way of limitation.

As illustrated in FIG. 2, the system of the preferred embodiment of the invention includes, in addition to terminal 2 arranged as set forth above, a certification authority/smart card management system 4 that issues smart cards 6 containing one or more signer certificates 9, one or more private keys 3 corresponding to the signer certificates for generating digital signatures, and PINs 13 for enabling controlled access to the digital signing process carried out by the file signing tool 5 for the purpose of signing the above-described prompt table files.

Optionally, to protect the private key, smartcards 6 may be arranged to store the private key 3 in such a manner that the private key can only be accessed by a secure processor embedded in the smartcard, the secure processor being programmed so that it performs all digital signing operations that require access to the stored private key. In addition, further protection for the signing operation may be provided by requiring entry of one or more PINs before the smartcard can be used in a prompt table file signing operation.

Smartcards that include a secure processor and the capability of storing information in a manner that ensures that the stored information can only be accessed by the secure processor are commercially available from a number of sources, and the present invention can use any such smartcards. In addition, the present invention could utilize other types of portable storage/processing devices, including optical cards having internal secure processors. The exact structure of the smartcard is not critical, so long as the smartcard is capable of performing all necessary file signing operations that require access to the stored private key. It is possible, for example, to perform all digital signing operations on the smartcard, or to assign operations that do not require key access to the file signing tool 5. Of course, it is essential that the private key (or keys) stored on the card cannot be accessed by physically tampering with the card, but tamper protection features are readily available in conventional smartcards.

In the preferred embodiment of the invention, the entity that prepares the smartcard 6 is certification authority/smartcard management system 4. While the certification authority/smartcard management system of the preferred embodiment of the invention is not to be limited to a particular hardware configuration, one possible configuration is a regular PC 7 running Windows NT, a smartcard DataCard reader/printer 5 that prints information on the cards and that loads the private keys and certificates into the smartcard, and a GCR410 smartcard reader used to validate the generated smartcard before sending it out. The private key may be generated by any private-public key generating algorithm, of which a number are well-known.

Also in the preferred embodiment, the signer certificate 9 associated with the private key 3 stored on the card may, by way of example and not limitation, comply with the IUT X509-V3 generic certificate standard, and in particular the PKIX-X509 profile. Since this is a publicly available standard well-known to those skilled in the art, further certificate definitions are not included herein, except to note that several private field extensions to the pre-defined version, serial number, algorithm identifier, issuer, validity period, key owner name, public key, and signature fields of the certificate may be added to define specific key properties. Especially advantageous are extensions that limit file types attached to the certificate, key width (which permits multiple keys to be loaded in the same field is the key is “narrow,” for example in the case of sponsor certificates), and an identifier for a replacement certificate.

The customer file signing tool 5 may also include a regular PC 10 running Windows NT, and a GCR410 smartcard reader 11 that receives the smartcard and uses it to process the prompt table files for downloading to the terminal 1. In particular, the file signing tool must at least be capable of receiving the prompt table file and supplying data necessary to the digital signing process to the smartcard reader for transfer to the smartcard, of receiving the digital signature 12 from the smartcard, and of supplying the digitally signed prompt table file to the terminal 1, preferably together with the signer certificate retrieved from the smartcard.

If the smartcard is to be protected by a PIN 13, then the file signing tool 5 must be capable of relaying an input PIN to the smartcard for comparison with a PIN stored on the card by the certification authority 4. In order to enable multiple PINs to be established, it is simply necessary to include a field in the memory area of the card designating the number of PINs, and to store the multiple PINs on the card. Corresponding PINs must be sent separately from the certification authority to the file signing entity, for distribution to the person or persons that carry out the file signing. These PINs may be distributed to multiple individuals and correct entry of all PINs required to enable signing of a file, thus ensuring that a single individual cannot access the card without cooperation from all PIN holders, or the multiple PINs may be associated with multiple access levels. In the latter case, one PIN might be used to permit signing of certain non-critical types of files, while multiple PINs might be required to permit signing of critical file types.

As indicated above, terminal 2 is a PINpad having the capability of authenticating a downloaded file by decrypting the digital signature 12 with a corresponding public key 14 derived from the signer's public key certificate 9, and of authenticating the public key certificate 9 by means of an owner's certificate 15 that has previously been installed in the terminal, for example by the certification authority, and preferably by using appropriate authentication procedures. One example of such a transaction terminal is manufactured by VeriFone, Inc., a division of Hewlett Packard, which utilizes a single chip microcontroller with GPV3 functionality implemented as an on-chip hard-coded ROM and fixed-use RAM with sufficient input/output capabilities to drive a display, scan a keypad, support a magnetic card reader and primary interface, and a communications port for communicating with a main processor internal or external to the host platform. Additional support for authentication may be provided by an optional transaction speed coprocessor arranged to provide RSA cryptography functions, and to communicate with the core processor by means of triple DES encoding or a similar data protection algorithm. The input/output features of the terminal may be omitted when the core is used as a security module in a PINpad.

Such a terminal is capable of receiving the prompt table file downloaded from the file signing tool, and of authenticating the file by extracting the public key 14 from the signer certificate 9, decrypting the digital signature 12 using the public key 14, and comparing the values extracted from the decrypted digital signature with either (i) a reference value, (ii) values extracted from the signed file, and/or (iv) values extracted from the signer certificate, depending on the specific algorithms used to generate the digital signature, and on the specific authentication method used by the terminal, which may be pre-determined or selected based on information provided in the public key certificate.

If the signer certificate used to authenticate the prompt table file is downloaded to the terminal 2 together with the digitally signed file, then it is necessary for the terminal to authenticate the signer certificate. In the embodiment illustrated in FIG. 1, the signer certificate is signed by the certification authority 4 and authenticated by an owner or sponsor certificate previously installed in the terminal.

Although not shown, the terminal may also include further certificates used to authenticate the one or more owner or sponsor certificates during installation. The terminal 2 may include a single partition or multiple partitions which can be assigned to different sponsors, such as different banks and/or credit card companies, for storing application programs that control data communications, customer prompts, and so forth. Each of these partitions has a different owner's or sponsor's certificate for authenticating signer's certificates.

The partitions may, preferably, be arranged in a hierarchy that permits different levels of authentication within a partition. Initially, the terminal is provided with a root platform certificate in a secure root directory. The root certificate is used to authenticate an operating system partition certificate and an application partition certificate that permit operating software loaded by the manufacturer or that authenticates the operating system owner certificate of another party such as the key management authority to be authenticated so that the other party can load operating system software, and that permits the key management authority to authenticate owner or sponsor certificates for the application areas of the terminal.

Although not required by the present invention, the partitions may advantageously be arranged in a hierarchy that permits different levels of authentication within a partition. Initially, the terminal is provided with a root platform certificate in a secure root directory. The root certificate is used to authenticate an operating system partition certificate and an application partition certificate that permit operating software loaded by the manufacturer or that authenticates the operating system owner certificate of another party such as the key management authority to be authenticated so that the other party can load operating system software, and that permits the key management authority to authenticate owner certificates for the application areas of the terminal.

In addition to securing the terminal against unauthorized access through file transfers, the terminal should of course be physically secured, for example by arranging the terminal to erase information if an attempt is made to pry open the case without proper authentication, or that renders the terminal inoperative upon repeated such attempts. Similar protection against physical tampering may also be provided for the smartcard or secure processing unit. Such tamper prevention arrangements are well-known and are not part of the present invention.

Turning to FIG. 3, the specific authentication method used in the preferred embodiment of the invention involves three principal subroutines or sub-methods carried out, respectively, by certification authority 4, file signing tool 5, and terminal 2: certification, signing, and authentication. The certification subroutine begins when a request for a sponsor certificate is received by the certification authority (step 200). The certification authority then collects data concerning the identity of the requester for the purpose of creating the certificate or, if the requester is an existing customer, authenticates the requester (step 210) by asking the requester to the use the file signing tool and an existing signer certificate to sign a file supplied by the certification authority, thus enabling the certification authority to verify that the requester is entitled to new signer or clear certificates for a particular sponsor certificate. The order is then confirmed by the requester, signer certificates for the previously generated sponsor certificate are generated, and the signer certificates, private key(s), and PIN(s) are loaded onto a smartcard (step 220). Finally, the smartcard is sent to the requester (step 230), as is a separate communication containing the PIN(s) necessary to use the smartcard.

When the sponsor wishes to load a prompt table file into a terminal, the prompt table file is transferred to the file signing tool, (step 240), the smartcard is inserted into the card reader of the file signing tool (step 250), and all necessary PINs are input (step 260). If the set of entered PINs is complete and correct, the file signing tool generates a digital signature (step 270), retrieves the signer certificate (step 280), and then downloads the digitally signed file together with the signer certificate to the terminal (step 290).

Upon receipt of the digitally signed prompt table file, the terminal authenticates the file by decrypting the digital signature and verifying that the resulting plaintext information or values correspond to those included in the signer certificate (step 300). The terminal then authenticates the signer certificate by referring to a sponsor certificate previously stored or loaded into the terminal (step 310), completing the authentication process.

Having thus described a preferred embodiment of the invention in sufficient detail to enable those skilled in the art to make and use the invention, it will nevertheless be appreciated that numerous variations and modifications of the illustrated embodiment may be made without departing from the spirit of the invention, and it is intended that the invention not be limited by the above description or accompanying drawings, but that it be defined solely in accordance with the appended claims.

We claim:

1. A system for securing input of non-PIN data using a numeric keypad of a PINpad terminal, comprising:
a dynamic prompt table file arranged to permit numeric keys on the keypad to be used for entry of non-PIN data if and only if an appropriate prompt has been, and continues to be, displayed at the time of data entry; and
a file authentication arrangement for authenticating said dynamic prompt table file upon loading of the dynamic prompt table file in the terminal.

2. A system as claimed in claim 1, wherein said file authentication arrangement includes a private key and a corresponding public key certificate containing information necessary to authenticate the prompt table file.

3. A system as claimed in claim 2, wherein said private key is stored on a smartcard and is only accessible by a secure processor embedded in the smartcard.

4. A system as claimed in claim 2, further comprising a file signing tool for digitally signing said clear file, said file signing too including a smartcard reader, and wherein all digital signing operations requiring access to said private key are carried out by a secure processor embedded in a smartcard inserted into said smartcard reader.

5. A system as claimed in claim 2, wherein said smartcard further has stored thereon a signer certificate for authenticating said digital signature, said signer certificate being authenticated by a sponsor certificate pre-installed in the terminal.

6. A method of securing input of non-PIN data using a numeric keypad of a PINpad terminal, comprising the steps of:
providing a dynamic prompt table file arranged to permit numeric keys on the keypad to be used for entry of non-PIN data if and only if an appropriate prompt has been, and continues to be, displayed at the time of data entry; and
authenticating said dynamic prompt table file upon loading of the dynamic prompt table file into the terminal.

7. A method as claimed in claim 6, wherein said authenticating step comprises the step of digitally signing the prompt table file using a private key, and appending to the signed prompt table file a corresponding public key certificate containing information necessary to authenticate the prompt table file.

8. A system as claimed in claim 7, further comprising the steps of storing said private key on a smartcard and only permitting a secure processor embedded in the smartcard to access the private key.

9. A system as claimed in claim 8, wherein all digital signing operations requiring access to said private key are carried out by said secure processor.

10. A system as claimed in claim 7, wherein said smartcard further has stored thereon a signer certificate for authenticating said digital signature, said signer certificate being authenticated by a sponsor certificate pre-installed in the terminal.
